(19) United States
(12) Patent Application Publication
(10) Pub. No.: US 2026/0257932 A1
(43) Pub. Date: Sep. 3, 2026

(54) PRUSSIAN-BLUE ANALOGUE (PBA) ION-CHROMATOGRAPHY-BASED METHOD FOR SELECTIVE SEPARATION OF RUBIDIUM FROM BRINE

(71) Applicant: TECHNION RESEARCH AND DEVELOPMENT FOUNDATION LIMITED, Haifa (IL)

(72) Inventors: Ori LAHAV, Haifa (IL); Chen DAGAN JALDETY, Haifa (IL); Paz NATIV, Haifa (IL)

(21) Appl. No.: 19/639,525

(22) Filed: Apr. 6, 2026

Related U.S. Application Data
(63) Continuation of application No. PCT/IL2024/050980, filed on Oct. 7, 2024.
(60) Provisional application No. 63/588,731, filed on Oct. 8, 2023.

(51) Int. Cl. C01D 17/00; B01D 15/18; B01D 15/20; B01D 15/36; B01D 15/42; B01J 39/02; B01J 39/09; B01J 47/02; B01J 49/53; C02F 1/42; C02F 101/20; C02F 103/34; C22B 3/42; C22B 26/10

(52) U.S. Cl. CPC C01D 17/00; B01D 15/1871; B01D 15/203; B01D 15/362; B01D 15/426; B01J 39/02; B01J 39/09; B01J 47/02; B01J 49/53; C02F 1/42; C22B 3/42; C22B 26/10; C02F 2001/425; C02F 2101/20; C02F 2103/34

(57) ABSTRACT

The present invention relates to a process for separating rubidium ions from saline solutions rich in other monovalent ions, particularly sodium and potassium. The process relies on rubidium ions adsorption via ion exchange performed by metal-hexacyanoferrate particles. The process of the present invention provides pure rubidium salt with estimated production costs that do not exceed 20% of the current price.

### CROSS-REFERENCE TO RELATED APPLICATIONS

The present application is a continuation of PCT application PCT/IL2024/050980, filed Oct. 7, 2024, the entire contents of which is incorporated herein by reference. PCT application PCT/IL2024/050980 claims priority from U.S. provisional patent application 63/588,731, filed Oct. 8, 2023.

### FIELD OF INVENTION

The present invention relates to a method for the selective separation of rubidium from saline water using ion-chromatography.

### BACKGROUND

As a member of the alkali metals group, rubidium (Rb) stands out for its high reactivity due to its position as the second most electropositive element and its low ionization energy. The metal has a wide range of uses in various industries such as fiber optics, semiconductors, and monolithic laser fabrication. Rubidium chloride (RbCl) is used to introduce DNA into living cells and as a biomarker in the human body. Metallic rubidium is also used in the development of new quantum mechanics-based computing devices and atomic clocks.

Despite being the 23^{rd} most abundant mineral on Earth's crust, the annual worldwide production of rubidium compounds is low (2-4 tons/year) due to the rarity of easily extractable rubidium-rich minerals. The combination of its scarcity and high demand renders it an expensive commodity (~$18,000/kg as metal and ~$6,700/kg as RbCl salt—metal basis). According to a recent USGS report, in the USA, rubidium is mainly produced as a byproduct of pollucite (a cesium-containing mineral) and lepidolite (a lithium-containing mineral) mining. In addition to traditional production methods, rubidium can be found as an ion at low concentrations in seawater and various natural brines. However, extracting it from these sources is, to date, not economic, due to a high concentration of competing cations such as Na⁺, Mg²⁺, Ca²⁺, and K⁺.

Transition metal hexacyanoferrates (Me-HCF), also known as Prussian blue analogs (PBA), can act as adsorbing materials due to their known high affinity towards alkali metals and NH₄⁺. Me-HCFs are coordination polymers with cubic skeletons formed from transition metal ions with CN bridges. Me-HCFs are used in various applications such as selective removal of NH₄⁺ (Nativ et al., Water Res. 203 (2021), https://doi.org/10.1016/j.watres.2021.117551; Parajuli et al., Ind Eng Chem Res. 55 (2016) 6708-6715, https://doi.org/10.1021/acs.iecr.6b00748; Tanaka et al., Environmental Pollution. 284 (2021) 117495, https://doi.org/10.1016/j.envpol.2021.117495; Nativ et al., ChemEngineering. 6 (2022) 97, https://doi.org/10.3390/chemengineering6060097; and Jiang et al., RSC Adv. 8 (2018) 34573-34581, https://doi.org/10.1039/C8RA07421F) and Cs⁺ (Wang et al., Coord Chem Rev. 374 (2018) 430-438, https://doi.org/10.1016/j.ccr.2018.07.014), Na⁺-ion batteries (Gupta et al., ACS Omega. 7 (2022) 5605-5614, https://doi.org/10.1021/acsomega.1c05794), and biosensors (Karyakin, Curr Opin Electrochem. 5 (2017) 92-98, https://doi.org/10.1016/j.coelec.2017.07.006).

Acting as ion-exchange materials, Me-HCFs are known to be able to adsorb Rb⁺ even in the presence of a high ionic background, while the Rb⁺ ions can also be desorbed into a high-concentration regeneration solution (1-4 M) comprising a counter-cation such as Na⁺ or K⁺ (Quyet Truong et al., Chem Eng J. 454 (2023), https://doi.org/10.1016/j.cej.2022.140107). However, such a procedure is problematic for selective separation and possible reuse, since it requires the transition of the separated cation from one high-ionic background (e.g., saline brine) to another (e.g., 1-4 M KCl). While such an outcome may be desired when the removal of an ion is required (for example NH₄⁺ can be easily removed from a KCl solution by indirect electro-oxidation or high-pH stripping), when the aim is to extract the cation as a commodity, a different regeneration methodology is required.

Chromatography is a commonly used separation technique in analytical chemistry. It is used for separating mixtures into their components by exploiting differences in their physical and chemical properties. The technique is based on the interaction between molecules in a sample that flows through a stationary phase. Ion chromatography utilizes an ion-exchange mechanism to separate ions based on their charge, hydrated size, and chemical properties.

A limited number of articles have addressed the selective separation of cations from Me-HCF substrates via chromatography. These studies demonstrated separations using different resins, including zinc, chromium, and vanadium-HCF, with high eluent concentrations of HNO₃ and NH₄NO₃ utilized in volumes of just a few milliliters (Kouim et al., J Inorg Nuc Chem. 26 (1964) 1111-1115, https://doi.org/10.1016/0022-1902(64)80271-2; Krtil, J Chromatog. 21 (1966) 85-91, https://doi.org/10.1016/S0021-9673(01)91263-4; and Malik et al., J Radioanal Chem. 36 (1977) 469-477, https://doi.org/10.1007/bf02517015). The results show high recovery percentages that varied based on the separated alkali metal ion and the applied eluent.

A separation process for extracting rubidium from carnallite sourced from the Dead Sea in Israel was reported by Ratner et al. (J Chem Tech Biotech. Chem Tech. 35 A (1985) 209-216, https://doi.org/10.1002/jctb.5040350502). A multi-stage approach, involving sequential decompositions and recrystallization of carnallite was described. Subsequently, a two-step displacement ion-exchange-chromatography technique was employed. In the first step, Rb⁺ was separated alongside K⁺ from Na⁺, NH₄⁺, and Mg⁺² using a polystyrene-sulphonic acid resin. This was followed by isolation of RbCl from K⁺ through a second ion-exchange process using a nitrated polystyrene-sulphonic resin and CaCl₂) as the eluent. The reported findings demonstrated a notably high purity of the RbCl solution obtained through this procedure.

There is an unmet need for an efficient and cost-effective method for selectively separating rubidium ions from saline (waste) water.

### SUMMARY

The present invention relates to a process for the selective separation of rubidium ions from a saline solution. The process of the present invention utilizes two or more metal-hexacyanoferrates columns through which the saline solution and eluent solutions flow. Due to the uniquely high selectivity of the metal-hexacyanoferrates towards specific monovalent cations and the negligible selectivity towards multivalent cations, Rb⁺ ions can be effectively separated from complex solutions via ion exchange. The process of the present invention affords a remarkable separation of RbCl from a saline solution comprising a plurality of ionic species, resulting in a high purity level of the obtained rubidium salt. Furthermore, the process of the present invention is economic, saving both capital expenditure (CAPEX) and operational expenditure (OPEX), and is amenable for use in large-scale rubidium production plants.

Disclosed herein for the first time is a selective ion-chromatography based technique for Rb⁺ separation from brine solutions. The technique utilizes two or more columns comprising beads of Prussian blue analogs as the stationary phase that selectively adsorb the rubidium ions while releasing the undesired cations including sodium and potassium ions to mobile tailored eluent solutions. The technique provides the time-based separation between the cations, thereby providing rubidium salt at high purity and yield that can be subsequently used in various industries such as fiber optics, semiconductors, monolithic laser fabrication, biomedical, quantum mechanics-based computing devices, and atomic clocks, among others.

According to a first aspect, there is provided a process for the selective separation of rubidium ions from saline water, the process comprising the steps of:
(a) passing saline water comprising rubidium ions and at least one of sodium ions and potassium ions through a first column comprising a plurality of metal-hexacyanoferrate particles pre-loaded with cations selected from Na⁺, H⁺, and a combination thereof;
(b) passing a first eluent solution through the first column of step (a);
(c) treating the permeate of step (b) to remove cations derived from the first eluent solution;
(d) passing the treated permeate of step (c) through a second column comprising a plurality of metal-hexacyanoferrate particles pre-loaded with cations selected from NH₄⁺, H⁺, and a combination thereof; and
(e) passing a second eluent solution through the second column of step (d) thereby obtaining selective separation of rubidium ions from the saline water.

In one embodiment, the water is wastewater. In another embodiment, the water is wastewater derived from phosphate industrial waste or potassium industrial waste. Each possibility represents a separate embodiment. In yet another embodiment, the water is obtained from a source selected from an ocean, a sea, a river, a lake, a spring, and an inland water body. Each possibility represents a separate embodiment. In particular embodiments, the water is seawater or the retentate derived from seawater desalination (e.g., RO) operation. Each possibility represents a separate embodiment.

In some embodiments, the water comprises rubidium ions and sodium ions, wherein the concentration of the sodium ions is at least 100-fold higher than the concentration of rubidium ions. In other embodiments, the water comprises rubidium ions and sodium ions, wherein the concentration of the sodium ions is at least 1,000-fold higher than the concentration of rubidium ions. In additional embodiments, the water comprises rubidium ions and potassium ions, wherein the concentration of the potassium ions is at least 10-fold higher than the concentration of rubidium ions. In further embodiments, the water comprises rubidium ions and potassium ions, wherein the concentration of the potassium ions is at least 100-fold higher than the concentration of rubidium ions. In certain embodiments, the water further comprises cesium ions and/or lithium ions. Each possibility represents a separate embodiment.

In some embodiments, the metal-hexacyanoferrate particles comprise a metal selected from the group consisting of zinc, cobalt, copper, nickel, chromium, vanadium, iron, and combinations thereof. Each possibility represents a separate embodiment. In other embodiments, the metal-hexacyanoferrate particles comprise a metal selected from the group consisting of zinc, cobalt, copper, nickel, and combinations thereof. Each possibility represents a separate embodiment. In particular embodiments, the metal-hexacyanoferrate is zinc-hexacyanoferrate.

In certain embodiments, the metal-hexacyanoferrate particles are coated with or embedded in a polymer selected from polyether sulfone, polyester, polyurethane, polypropylene, polystyrene, polycarbonate, polyimide, polyphenylene, polyamide, polyether imide, polyphenyl sulfone, polyvinyl, polysulfone, polyvinylidene fluoride, polytetrafluoroethylene, and a mixture or combination thereof. Each possibility represents a separate embodiment. In one embodiment, the metal-hexacyanoferrate particles are coated with or embedded in polyether sulfone.

In other embodiments, the metal-hexacyanoferrate particles are in the form of beads, pellets, granules, flakes, or a mixture or combination thereof. Each possibility represents a separate embodiment. In specific embodiments, the metal-hexacyanoferrate particles are in the form of beads having an average diameter in the range of about 0.1 μm to about 10 mm, including each value within the specified range. In other specific embodiments, the metal-hexacyanoferrate particles are in the form of beads having an average diameter in the range of about 0.5 μm to about 5 mm, including each value within the specified range.

In various embodiments, the flow rate at which the saline water and/or eluent solutions are passed through the columns ranges from about 0.1 BV/h to about 4 BV/h, including each value within the specified range. In other embodiments, the flow rate at which the saline water and/or eluent solutions are passed through the columns ranges from about 0.1 BV/h to about 2 BV/h, including each value within the specified range.

In certain embodiments, the process further comprises step (aᵢ) of measuring the content of rubidium ions of the total ions adsorbed onto the metal-hexacyanoferrate particles following step (a), wherein if the content of rubidium ions adsorbed onto the metal-hexacyanoferrate particles is at or below a predetermined threshold, the process further comprises the steps of: (aᵢᵢ) regenerating the metal-hexacyanoferrate particles of step (a) using a solution comprising cations selected from NH₄⁺, H⁺, and a combination thereof; (aᵢᵢᵢ) treating the permeate of step (aᵢᵢ) to remove the NH₄⁺ and/or H⁺ ions; and (aᵢᵥ) passing the treated permeate of step (aᵢᵢᵢ) through the regenerated column of step (aᵢᵢ). In particular embodiments, steps (aᵢ) to (aᵢᵥ) are repeated until the content of rubidium ions adsorbed onto the metal-hexacyanoferrate particles is above the predetermined threshold. In some embodiments, the predetermined threshold for the content of rubidium ions adsorbed onto the metal-hexacyanoferrate is about 3%, 5%, 8%, 10%, or 15% (eq/eq). Each possibility represents a separate embodiment. In particular embodiments, the predetermined threshold for the content of rubidium ions adsorbed onto the metal-hexacyanoferrate particles is about 8%. In various embodiments, regeneration of the metal-hexacyanoferrate particles in step (aᵢᵢ) is performed using a solution comprising NH₄⁺ ions at a concentration in the range of about 0.01M to about 3M, including each value within the specified range. In other embodiments, regeneration of the metal-hexacyanoferrate particles in step (aᵢᵢ) is performed using a solution comprising H⁺ ions at a concentration in the range of about 0.1M to about 6M, including each value within the specified range. In yet other embodiments, treating the permeate of step (aᵢᵢ) to remove the NH₄⁺ ions is performed by one or more of sublimation of ammonium salt, electro-oxidation, and high-pH stripping. Each possibility represents a separate embodiment. In specific embodiments, treating the permeate of step (aᵢᵢ) to remove the NH₄⁺ ions is performed by the sublimation of ammonium salt. In certain such embodiments, sublimation is performed at a temperature higher than 200° C. In further embodiments, treating the permeate of step (aᵢᵢ) to remove H⁺ ions is performed by one or more of pH neutralization, and acid evaporation. Each possibility represents a separate embodiment.

In some embodiments, the first eluent solution comprises NH₄⁺ ions. In other embodiments, the first eluent solution comprises NH₄⁺ ions at a concentration in the range of about 0.01M to about 0.1M, including each value within the specified range. In accordance with these embodiments, step (c) comprises treating the permeate of step (b) to remove NH₄⁺ ions by one or more of sublimation of ammonium salt, electro-oxidation, and high-pH stripping. Each possibility represents a separate embodiment. In specific embodiments, treating the permeate of step (b) to remove NH₄⁺ ions is performed by the sublimation of ammonium salt. In certain such embodiments, sublimation is performed at a temperature higher than 200° C.

In various embodiments, the first eluent solution comprises H⁺ ions. In other embodiments, the first eluent solution comprises H⁺ ions at a concentration in the range of about 0.1M to about 6M, including each value within the specified range. In accordance with these embodiments, step (c) comprises treating the permeate of step (b) to remove H⁺ ions by one or more of pH neutralization, and acid evaporation. Each possibility represents a separate embodiment.

In additional embodiments, the second eluent solution comprises NH₄⁺ ions. In other embodiments, the second eluent solution comprises NH₄⁺ ions at a concentration in the range of about 0.01M to about 3M, including each value within the specified range. In yet other embodiments, the second eluent solution comprises H⁺ ions. In further embodiments, the second eluent solution comprises H⁺ ions at a concentration in the range of about 0.1M to about 6M, including each value within the specified range. In some embodiments, the second eluent solution comprises NH₄⁺ ions and/or H⁺ ions at a higher concentration than the concentration of NH₄⁺ ions and/or H⁺ ions in the first eluent solution. In one embodiment, the second eluent solution comprises NH₄⁺ ions and/or H⁺ ions at a concentration which is at least 1.5-fold higher than the concentration of NH₄⁺ ions and/or H⁺ ions in the first eluent solution. In another embodiment, the second eluent solution comprises NH₄⁺ ions and/or H⁺ ions at a concentration which is at least 2-fold higher than the concentration of NH₄⁺ ions and/or H⁺ ions in the first eluent solution. In yet another embodiment, the second eluent solution comprises NH₄⁺ ions and/or H⁺ ions at a concentration which is at least 5-fold higher than the concentration of NH₄⁺ ions and/or H⁺ ions in the first eluent solution. In additional embodiments, the second eluent solution comprises NH₄⁺ ions and/or H⁺ ions at a concentration which is at least 10-fold higher than the concentration of NH₄⁺ ions and/or H⁺ ions in the first eluent solution.

In various embodiments, steps (b) through (d) are performed continuously. In certain such embodiments, the first eluent solution is passed through the first and the second columns which are connected. Without being bound by any theory or mechanism of action, it is contemplated that when passing the first eluent through the first column, sodium and potassium ions are desorbed from the metal-hexacyanoferrate particles and passed through the second column without being adsorbed thereto. Thus, sodium and potassium are washed out at this stage. While some rubidium ions may also be desorbed from the first column upon passage of the first eluent, according to the principles of the present invention these ions are adsorbed onto the second column which is pre-adsorbed with NH₄⁺ ions, H⁺ ions, or a combination thereof. According to additional embodiments, steps (b) through (d) are repeated until substantially no sodium and/or potassium ions which are desorbed from the metal-hexacyanoferrate particles upon passage of the first eluent are released.

In some embodiments, step (e) comprises releasing the rubidium ions which were adsorbed onto the first and second columns.

It is to be understood that while the process of the present invention may be performed using a first column and a second column each comprising a plurality of metal-hexacyanoferrate particles pre-loaded with cations as detailed herein, the process further comprises utilization of n number of columns each comprising a plurality of metal-hexacyanoferrate particles pre-loaded with cations to afford the separation of rubidium ions from saline water.

In further embodiments, steps (a) through (e) are performed at a temperature range of about 10° C. to about 70° C., including each value within the specified range. In other embodiments, steps (a) through (e) are performed at room temperatures.

In various embodiments, the eluent solutions comprise counterions selected from the group consisting of SO₄²⁻, NO₃⁻, Cl⁻, and combinations thereof. Each possibility represents a separate embodiment. In specific embodiments, the eluent solutions comprise Cl⁻ counterions.

In additional embodiments, the process further comprises step (f) of treating the permeate of step (e) to remove cations derived from the second eluent solution. In various embodiments, removal of NH₄⁺ ions is performed by one or more of sublimation of ammonium salt, electro-oxidation, and high-pH stripping. Each possibility represents a separate embodiment. In one embodiment, removal of NH₄⁺ ions is performed by sublimation of ammonium salt. In certain such embodiments, sublimation is performed at a temperature higher than 200° C. In further embodiments, when the eluent solutions comprise Cl⁻ counterions, sublimation of ammonium chloride is performed to obtain ammonia gas and HCl gas. In accordance with these embodiments, the NH₃ and HCl can be further recycled for subsequent use. In various embodiments, removal of H⁺ ions is performed by one or more of pH neutralization, and acid evaporation. Each possibility represents a separate embodiment.

In some embodiments, the process further comprises step (g) of regenerating the first column using sodium ions or acids. In one embodiment, the acid is selected from the group consisting of hydrochloric acid, sulfuric acid, nitric acid, acetic acid, and a combination thereof. Each possibility represents a separate embodiment.

In one embodiment, the purity of the rubidium salt obtained by the process of the present invention is at least 90 wt. %. In another embodiment, the purity of the rubidium salt obtained by the process of the present invention is at least 95 wt. %. In yet another embodiment, the purity of the rubidium salt obtained by the process of the present invention is at least 98 wt. %. In further embodiments, the purity of the rubidium salt obtained by the process of the present invention is at least 99 wt. %. In certain embodiments, the content of sodium and/or potassium ions in the rubidium salt obtained by the process of the present invention is less than 10 wt. %. In other embodiments, the content of sodium and/or potassium ions in the rubidium salt obtained by the process of the present invention is less than 5 wt. %. In yet other embodiments, the content of sodium and/or potassium ions in the rubidium salt obtained by the process of the present invention is less than 2 wt. %. In particular embodiments, the content of sodium and/or potassium ions in the rubidium salt obtained by the process of the present invention is less than 1 wt. %.

In additional embodiments, the efficacy of separation of rubidium ions from the saline water is at least 30%. In other embodiments, the efficacy of separation of rubidium ions from the saline water is at least 40%. In yet other embodiments, the efficacy of separation of rubidium ions from the saline water is about 50%. In further embodiments, the yield of the process of the present invention is at least 10%, for example 10% to 30%, including each value within the specified range.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIG. 1 depicts a schematic illustration of the process of separating RbCl using a two-column PES-Zn-HCF setup according to some embodiments of the present invention. Following the adsorption step, the first column is saturated with a mixture of Na⁺, K⁺, and Rb⁺ ions and the second column is pre-loaded with NH₄⁺.

FIG. 2 depicts binary affinity coefficients measured for PES-Zn-HCF beads for the ions K⁺, NH₄⁺, and Rb⁺ versus Na⁺, as measured in background solutions containing various concentrations of NaCl (25° C., n=3, background concentration=0, 1, 10.2, 30.5 and 61 g/L of NaCl).

FIG. 3 depicts PHREEQC simulation of the initial desorption step at NH₄Cl concentration of 0.5-2 M.

FIGS. 4A-4C depict high-resolution scanning electron microscopy (HRSEM) images of Zn-HCF. (4A) SEM image of Zn-HCF powder. (4B) SEM image of a PES-Zn-HCF bead. (4C) SEM image with EDS detector featuring the Rb, O and S elements.

FIGS. 5A-5B depict adsorption isotherms of Rb⁺ on Zn-HCF powder in SW background, at 25° C. (n=3). (5A) Full Rb⁺ adsorption isotherm at equilibrium concentrations ranging from 0.1 to 658 mg/L, adsorption time of 24 hours (circles) and 72 hours (triangles). (5B) Focus on the low Rb⁺ concentration range (0.1 to 15 mg/L), adsorption time of 24 hours (circles) and 72 hours (triangles).

FIGS. 6A-6B depict batch experiment results for Na⁺, K⁺ and Rb⁺ desorption from the PES-Zn-HCF beads in 0.05 and 1 M NH₄Cl, after 4 and 24 h; (6A) 25° C.; (6B) 35° C.

FIGS. 7A-7F depict PHREEQC-assisted simulations showing the monovalent cation concentrations leaving the columns, as a function of the BV. The first Zn-HCF column was assumed to be loaded with a mixture of K⁺, Na⁺, and Rb⁺ (molar ratio of 61%, 31%, and 8%, respectively). This was followed by a second column, fully pre-adsorbed with NH₄⁺. NH₄Cl was used as the eluent, at 0.05 (7A, 7D), 0.1 (7B, 7E) and 1 M (7C, 7F) concentrations; (7A-7C) cation concentrations in the solution flowing out of the first column; (7D-7F) cation concentrations in the solution flowing out of the second column.

FIGS. 8A-8D depict PHREEQC simulations vs. empirical results of the cation concentrations in the water flowing out of the first column; (8A) Na⁺, K⁺ and Rb⁺ concentrations with 0.05 M NH₄⁺ as the eluent; (8B) focus on Rb⁺ concentration with 0.05 M NH₄⁺ as the eluent; (8C) Na⁺, K⁺ and Rb⁺ concentrations with 0.1 M NH₄⁺ as the eluent; (8D) focus on Rb⁺ concentration with 0.1 M NH₄⁺ as the eluent.

FIGS. 9A-9B depict simulated and measured cation concentrations at the outlet of the 2^{nd} column, (dashed vertical line indicates transition from low to high eluent concentrations). (9A) Na⁺, K⁺ and Rb⁺ concentrations with 0.05 M NH₄⁺ as the first eluent; (9B) Na⁺, K⁺ and Rb⁺ concentrations with 0.1 M NH₄⁺ as the first eluent.

FIG. 10 depicts a general scheme of the process for Rb⁺ separation used in the cost assessment calculations according to some embodiments of the present invention.

FIG. 11 depicts a detailed scheme of the process for Rb⁺ separation used in the cost assessment calculations according to some embodiments of the present invention.

FIGS. 12A-12B depict breakthrough curve of Rb⁺ onto a PES-Zn-HCF column. (12A) Simulated phosphate industrial wastewater as adsorbent solutions, flow rate of 1 BV/h. Final adsorption of 1.4% out of the available adsorption sites (mmol Rb⁺ adsorbed/mmol adsorption sites); (12B) Second stage adsorption based on the salt maintained passed the sublimation diluted in a ratio of 1 to 3.4 L of DIW. Flow rate of 0.5 BV/h. 8% Rb⁺ adsorption achieved past 7.5 BV, with a final adsorption Rb⁺ capacity of 18%.

### DETAILED DESCRIPTION

The present invention relates to a process for the selective separation of rubidium ions from a solution characterized by a high concentration of Na⁺ and K⁺ cations. The process can be applied to various brines for producing a high-purity rubidium salt that can be utilized in various applications including electro-optics, biomedical, and quantum technologies.

Disclosed herein for the first time is a process that utilizes an adsorbing resin comprised of metal-cyanoferrate beads. In particular, the process includes passing a saline Rb⁺-containing solution through a first column packed with metal-cyanoferrate beads, passing a first eluent solution containing NH₄⁺ or H⁺ ions at a certain concentration through the first column, treatment of the eluent solution to remove competing counter cations, passing the thus obtained solution through a second metal-cyanoferrate column which is pre-adsorbed with NH₄⁺ or H⁺ ions, and passing a second eluent solution containing NH₄⁺ or H⁺ ions at a higher concentration than the first eluent solution through the first and second columns thereby releasing the adsorbed rubidium ions. The process of the present invention therefore provides a time-based separation between the rubidium cations and sodium/potassium cations, affording a rubidium salt at a high purity level.

For a better understanding of the invention and to show how it may be carried into effect, reference will now be made, purely by way of example, to the accompanying drawings. With specific reference now to the drawings in detail, it is stressed that the particulars shown are by way of example and for purposes of illustrative discussion of the preferred embodiments of the present invention only and are presented with the purpose of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

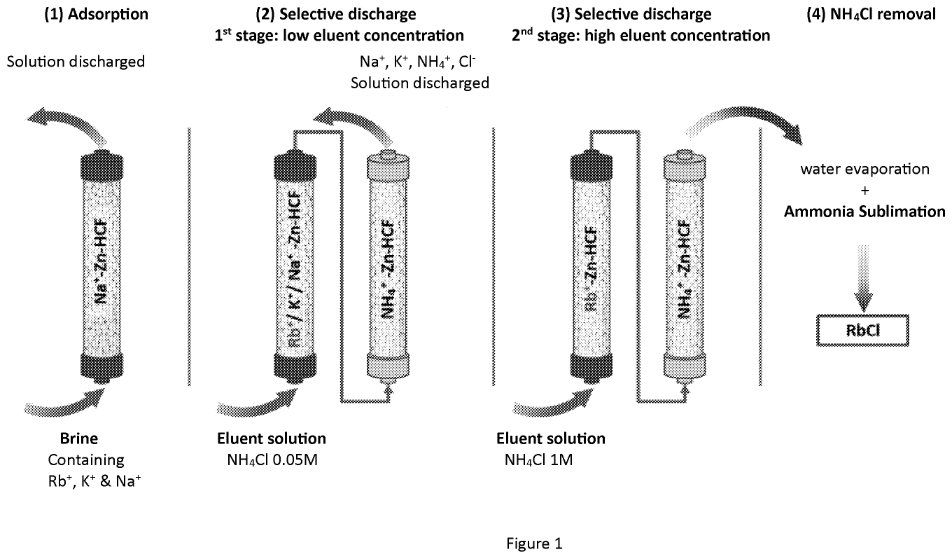

Reference is now made to FIG. 1, which is a schematic illustration of the process disclosed herein using a two-column Zn-cyanoferrate setup, according to some embodiments.

First, a saline solution containing rubidium ions is passed through a column packed with polyether sulfone-covered zinc-cyanoferrate (PES-Zn-HCF) beads. At this stage, adsorption of cations which are present in the saline solution such as Rb⁺, Na⁺, and K⁺ onto the PES-Zn-HCF beads occurs. Then, chromatography-based separation in which a first eluent solution containing a low NH₄Cl concentration (e.g., 0.05 M) is passed through the column and the thus obtained solution is passed through a second column containing PES-Zn-HCF beads which were pre-adsorbed with NH₄⁺ ions. Owing to the significant selectivity differences between the cations, Na⁺ and K⁺ are effectively washed out of the 2-column configuration, while a major portion of Rb⁺ is retained therein. The first eluent solution can be passed through the columns until the exiting solution is substantially free of the competing ions (i.e., Na⁺ and K⁺ cations). Finally, the Rb⁺ ions which were adsorbed onto the columns and therefore retained by them are released by passing a second eluent solution containing a higher NH₄Cl concentration (e.g., 1 M) through the columns. Subsequent removal of ammonia from the recovered solution can be accomplished as is known in the art, for example via indirect ammonia electrooxidation, NH₃ stripping at high pH, or by NH₃/HCl sublimation, ultimately yielding a pure RbCl(s) (99.5%) product.

According to some embodiments, if the absorption of Rb⁺ cations on the first column following the passage of the saline solution therethrough is lower than a predetermined threshold (e.g., 8%), the following additional steps are performed prior to the chromatography-based separation: regeneration of the first column using NH₄Cl, removal of the ammonium ions from the thus obtained solution, and passage of the ammonium-free solution through the regenerated column until the threshold of Rb⁺ cations absorption on the first column is reached. According to the principles of the present invention, the threshold is determined to afford efficient chromatographic separation of Rb⁺ cations from the saline water.

Thus, the process of the present invention provides the separation of RbCl from a saline (waste) solution owing to the remarkably high selectivity of the metal-hexacyanoferrates towards specific monovalent cations (Na⁺<K⁺<<NH₄⁺<Rb⁺<Cs⁺), with practically no selectivity towards multivalent cations. By employing chromatographic methods in a novel approach, rubidium salt is separated from a saline solution with a purity higher than 90%, 95%, 98% or even 99%. The described process is cost-effective and can be implemented in large-scale rubidium production plants.

According to the principles of the present invention, the process enables the selective separation of rubidium ions from saline water comprising rubidium ions and further comprising at least one additional ion having the same polarity. In some embodiments, the saline water comprises rubidium ions and further comprises at least one additional ion having the same ionic charge (or corresponding atom valency). Thus, for example, in addition to rubidium ions, the saline water comprises at least one of Na⁺ ions and K⁺ ions. Additional cations that may be present in the saline water include, but not limited to Cs⁺, Li⁺, Mg²⁺, and Ca²⁺ ions. Each possibility represents a separate embodiment.

Typically, the saline water comprises Rb⁺ ions and Na⁺ ions at a concentration ratio of at least 1:100. In some embodiments, the saline water comprises Rb⁺ ions and Na⁺ ions at a concentration ratio of at least 1:1,000. Exemplary concentration ratios of Rb⁺ ions to Na⁺ ions in the saline water include, but are not limited to, 1:100, 1:250, 1:500, 1:750, 1:1,000, 1:1,500, 1:2,000, 1:2,500, 1:3,000, 1:3,500, 1:4,000, 1:4,500, 1:5,000, 1:5,500, 1:6,000, 1:6,500, 1:7,000, 1:7,500, 1:8,000, 1:8,500, 1:9,000, 1:9,500, 1:10,000, and higher. Each possibility represents a separate embodiment. In some embodiments, the saline water comprises Rb⁺ ions and K⁺ ions at a concentration ratio of at least 1:10. In other embodiments, the saline water comprises Rb⁺ ions and K⁺ ions at a concentration ratio of at least 1:100. Exemplary concentration ratios of Rb⁺ ions to K⁺ ions in the saline water include, but are not limited to, 1:10, 1:20, 1:30, 1:40, 1:50, 1:60, 1:70, 1:80, 1:90, 1:100, 1:150, 1:200, 1:250, 1:300, 1:350, 1:400, 1:450, 1:500, 1:550, 1:600, 1:650, 1:700, 1:750, 1:800, 1:850, 1:900, 1:950, 1:1,000, and higher. Each possibility represents a separate embodiment.

The saline water may be obtained from various sources including wastewater and a natural water source. Any source of wastewater that contains rubidium ions can be used including, but not limited to, wastewater derived from phosphate industrial waste or potassium industrial waste. Each possibility represents a separate embodiment. Saline water can also be obtained from waste of seawater desalination, for example the retentate of reverse osmosis (RO) systems. In some embodiments, the saline water is derived from a natural water source. The term “natural water source” includes, but is not limited to, seas, oceans, rivers, lakes, water springs, inland water bodies, and the like. Each possibility represents a separate embodiment.

Encompassed by the present invention is the flow of the saline water and eluent solutions through columns containing a plurality of metal-hexacyanoferrate particles. The metal-hexacyanoferrate particles may be composed of a metal such as, but not limited to, zinc, cobalt, copper, nickel, chromium, vanadium, iron, and combinations thereof. Each possibility represents a separate embodiment. In some embodiments, the metal-hexacyanoferrate particles comprise zinc-hexacyanoferrate, cobalt-hexacyanoferrate, copper-hexacyanoferrate, nickel-hexacyanoferrate, and combinations thereof, where zinc-hexacyanoferrate is currently preferred.

The metal-hexacyanoferrate particles may be in any form or shape including, but not limited to, beads, pellets, granules, flakes, or a mixture or combination thereof. Each possibility represents a separate embodiment. In some embodiments, the metal-hexacyanoferrate particles are in the form of beads. Suitable metal-hexacyanoferrate beads within the scope of the present invention are characterized by an average particle size ranging from about 0.1 μm to about 10 mm, including each value within the specified range. In some embodiments, the metal-hexacyanoferrate beads are characterized by an average particle size ranging from about 0.5 μm to about 5 mm, including each value within the specified range. Exemplary average particle sizes of the beads include, but are not limited to, about 0.1 μm, about 0.5 μm, about 1 μm, about 5 μm, about 10 μm, about 15 μm, about 20 μm, about 50 μm, about 75 μm, about 100 μm, about 250 μm, about 500 μm, about 750 μm, about 1 mm, about 2 mm, about 3 mm, about 4 mm, about 5 mm, about 6 mm, about 7 mm, about 8 mm, about 9 mm, and about 10 mm, with each possibility representing a separate embodiment. In some embodiments, the beads are characterized by a narrow particle size distribution thereby affording the close packing of the beads within the column. In certain embodiments, the column is characterized by a porosity or column pore water volume ratio in the range of about 0.3 to about 0.6, including each value within the specified range. Exemplary porosity values of the column(s) include, but are not limited to, about 0.30, about 0.31, about 0.32, about 0.33, about 0.34, about 0.35, about 0.36, about 0.37, about 0.38, about 0.39, about 0.40, about 0.41, about 0.42, about 0.43, about 0.44, about 0.45, about 0.46, about 0.47, about 0.48, about 0.49, about 0.50, about 0.51, about 0.52, about 0.53, about 0.54, about 0.55, about 0.56, about 0.57, about 0.58, about 0.59, and about 0.60, with each possibility representing a separate embodiment.

Preparation of the metal-hexacyanoferrate particles can be performed as is known in the art, for example by mixing a solution comprising the metal ions with a hexacyanoferrate salt to precipitate the metal-hexacyanoferrate particles which can be subsequently separated from the solution by at least one of filtration, centrifugation, flotation, sedimentation, coagulation, flocculation, and decantation. Each possibility represents a separate embodiment. Further purification may be performed as is known in the art.

According to certain aspects and embodiments, the metal-hexacyanoferrate particles may be further encapsulated or embedded in a polymer. Suitable polymers within the scope of the present invention include, but are not limited to, polyether sulfone, polyester, polyurethane, polypropylene, polystyrene, polycarbonate, polyimide, polyphenylene, polyamide, polyether imide, polyphenyl sulfone, polyvinyl, polysulfone, polyvinylidene fluoride, polytetrafluoroethylene, and a mixture or combination thereof. Each possibility represents a separate embodiment. Currently preferred is the encapsulation of zinc-hexacyanoferrate in polyether sulfone (PES), characterized by the following repeating unit:

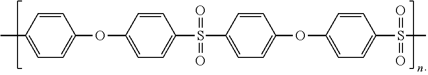

Additional materials that can be used for encapsulating metal-hexacyanoferrate particles include, but are not limited to, polyvinyl alcohol, alginates, chitosan, polyacrylonitrile, silica, and the like. Each possibility represents a separate embodiment.

Encapsulation of metal-hexacyanoferrate particles can be performed as is known in the art, for example by employing a phase inversion technique. In particular, the technique involves dissolving an encapsulating material such as a polymer in an organic solvent, admixing the solution with the metal-hexacyanoferrate particles, and contacting the mixture with an aqueous phase thereby affording the encapsulation of the metal-hexacyanoferrate particles by the polymer.

The metal-hexacyanoferrate particles are packed into the first and second columns as is known in the art. While the columns may be in any form, they are typically in the form of elongated cylinders having an inlet and an outlet to enable the flow of the saline water and eluent solutions therethrough. In some embodiments, the elongated cylinders are characterized by internal diameters ranging from about 1 cm to about 50 cm and heights ranging from about 30 cm to about 150 cm, including each value within the specified ranges.

According to the principles of the present invention, the process comprises a flow of the saline water through a first column of metal-hexacyanoferrate particles which is pre-loaded with cations comprising Na⁺ and/or H⁺. The term “pre-loaded” as used herein refers to occupancy of counterions which is up to 100% of the capacity of the column (i.e., full capacity). Thus, the capacity of the pre-loaded column is at least about 50%, about 55%, about 60%, about 65%, about 70%, about 75%, about 80%, about 85%, about 90%, about 95%, about 96%, about 97%, about 98%, about 99%, or more. Each possibility represents a separate embodiment. At the stage where a flow of the saline water is passed through the first column, adsorption of cations which are present in the saline water such as, but not limited to, Rb⁺, Na⁺, and K⁺ onto the metal-hexacyanoferrate particles occurs.

While the process disclosed herein may then proceed to the step of flowing the first eluent solution through the column, additional steps to ensure enhanced separation of rubidium ions may be performed. These steps include the determination of the content of rubidium ions of the total ions adsorbed onto the metal-hexacyanoferrate particles to assess whether the content of adsorbed rubidium meets a predetermined threshold. Suitable thresholds for the content of adsorbed rubidium ions include, but are not limited to, about 3%, about 4%, about 5%, about 6%, about 7%, about 8%, about 9%, about 10%, about 11%, about 12%, about 13%, about 14% and about 15% (eq/eq). Each possibility represents a separate embodiment.

If the content of rubidium ions of the total ions adsorbed onto the metal-hexacyanoferrate particles does not meet a predetermined threshold but is at or below it, then additional steps may be performed. These steps include the regeneration of the column with a solution of NH₄⁺ and/or H⁺ cations, removal of the NH₄⁺ and/or H⁺cations from the permeate, and flow of the permeate from which NH₄⁺ and/or H⁺ cations have been removed through the regenerated column. The forgoing steps may be repeated as necessary until the content of rubidium ions adsorbed onto the metal-hexacyanoferrate particles exceeds the predetermined threshold.

Typically, the regeneration of the column is performed using a solution comprising NH₄⁺ cations at a concentration in the range of about 0.01M to about 3M, including each value within the specified range. Exemplary concentrations include, but are not limited to, about 0.01M, about 0.05M, about 0.1M, about 0.2M, about 0.3M, about 0.4M, about 0.5M, about 0.6M, about 0.7M, about 0.8M, about 0.9M, about 1.0M, about 1.1M, about 1.2M, about 1.3M, about 1.4M, about 1.5M, about 1.6M, about 1.7M, about 1.8M, about 1.9M, about 2.0M, about 2.1M, about 2.2M, about 2.3M, about 2.4M, about 2.5M, about 2.6M, about 2.7M, about 2.8M, about 2.9M, and about 3.0M. Each possibility represents a separate embodiment. When H⁺ cations are used to regenerate the column, they are typically used at a concentration in the range of about 0.1M to about 6M, including each value within the specified range. Exemplary concentrations include, but are not limited to, about 0.1M, about 0.5M, about 1.0M, about 1.5M, about 2.0M, about 2.5M, about 3.0M, about 3.5M, about 4.0M, about 4.5M, about 5.0M, about 5.5M, and about 6.0M. Each possibility represents a separate embodiment.

The removal of NH₄⁺ and/or H⁺ cations from the permeate can be performed as is known in the art. For example, NH₄⁺ cations can be removed by sublimation of ammonium salt at a temperature higher than 200° C., typically in the range of about 200° C. to about 400° C., including each value within the specified range. Additional non-limiting methods of removing NH₄⁺ cations include electro-oxidation, and/or high-pH stripping. Each possibility represents a separate embodiment. Removal of H⁺ cations can be performed, for example by pH neutralization and/or acid evaporation. Each possibility represents a separate embodiment.

In some embodiments, removal of at least 50% of the initial NH₄⁺ and/or H⁺ cations is performed. In other embodiments, at least 60% of the initial NH₄⁺ and/or H⁺ cations are removed. In yet other embodiments, at least 70% of the initial NH₄⁺ and/or H⁺ cations are removed. In further embodiments, at least 80% of the initial NH₄⁺ and/or H⁺ cations are removed. In additional embodiments, at least 90% of the initial NH₄⁺ and/or H⁺ cations are removed.

The process disclosed herein comprises the flow of a first eluent solution through the first column following the adsorption of cations onto the metal-hexacyanoferrate particles. In some embodiments, the first eluent solution comprises NH₄⁺ cations. Typically, the concentration of NH₄⁺ cations is in the range of about 0.01M to about 0.1M, including each value within the specified range. Exemplary concentrations include, but are not limited to, about 0.01M, about 0.02M, about 0.03M, about 0.04M, about 0.05M, about 0.06M, about 0.07M, about 0.08M, about 0.09M, and about 0.1M. Each possibility represents a separate embodiment.

In various embodiments, the first eluent solution comprises H⁺ cations. Typically, the concentration of H⁺ cations is in the range of about 0.1M to about 6M, including each value within the specified range. Exemplary concentrations include, but are not limited to, about 0.1M, about 0.5M, about 1.0M, about 1.5M, about 2.0M, about 2.5M, about 3.0M, about 3.5M, about 4.0M, about 4.5M, about 5.0M, about 5.5M, and about 6.0M. Each possibility represents a separate embodiment.

According to the principles of the present invention, the NH₄⁺ and/or H⁺ cations are then removed from the permeate. Removal of NH₄⁺ cations can be performed by sublimation of ammonium salt, typically performed at a temperature higher than 200° C., for example about 200° C. to about 400° C., including each value within the specified range. Additionally or alternatively, removal of NH₄⁺ cations can be performed by electro-oxidation and/or high-pH stripping. Each possibility represents a separate embodiment. When H⁺ cations are used in the first eluent solution, they can be removed by one or more of pH neutralization, and acid evaporation. Each possibility represents a separate embodiment. Typically, removal of the NH₄⁺ and/or H⁺ cations is performed such that at least 50%, 60%, 70%, 80%, or 90% of the initial NH₄⁺ and/or H⁺ cations in the permeate are removed. Each possibility represents a separate embodiment.

The permeate from which the eluent cations have been removed is then flown through a second metal-hexacyanoferrate column which was pre-loaded with NH₄⁺ and/or H⁺ cations. Without being bound by any theory or mechanism of action, due to the difference in selectivity between rubidium cations and the additional cations including sodium and potassium cations, despite the latter being in significantly higher concentrations in the saline water, they are washed out during the flow through the two columns while Rb⁺ is selectively adsorbed by the columns in a large portion.

Encompassed by the present invention is the performance of the steps of flowing the first eluent solution, removing the cations of the first eluent solution from the permeate, and flowing the permeate through the second column in a continuous manner. According to some embodiments, these steps can be repeated as needed until substantially no release of sodium and/or potassium ions from the columns upon passage of the first eluent solution occurs.

The rubidium cations that were adsorbed on the particles of the columns can then be released from the columns using a second eluent solution comprising NH₄⁺ ions and/or H⁺ ions at higher concentrations than those of the first eluent solution. Typically, the concentration of the NH₄⁺ ions and/or H⁺ ions in the second eluent solution is at least 1.5-fold, 2-fold, 2.5-fold, 3-fold, 3.5-fold, 4-fold, 4.5-fold, 5-fold, 5.5-fold, 6-fold, 6.5-fold, 7-fold, 7.5-fold, 8-fold, 8.5-fold, 9-fold, 9.5-fold, or at least 10-fold higher than the concentration of NH₄⁺ ions and/or H⁺ ions in the first eluent solution.

In some embodiments, the second eluent solution comprises NH₄⁺ ions at a concentration in the range of about 0.01M to about 3M, including each value within the specified range. Exemplary concentrations include, but are not limited to, about 0.01M, about 0.05M, about 0.1M, about 0.2M, about 0.3M, about 0.4M, about 0.5M, about 0.6M, about 0.7M, about 0.8M, about 0.9M, about 1.0M, about 1.1M, about 1.2M, about 1.3M, about 1.4M, about 1.5M, about 1.6M, about 1.7M, about 1.8M, about 1.9M, about 2.0M, about 2.1M, about 2.2M, about 2.3M, about 2.4M, about 2.5M, about 2.6M, about 2.7M, about 2.8M, about 2.9M, and about 3.0M. Each possibility represents a separate embodiment. When the second eluent solution comprises H⁺ ions, they are typically at concentrations of about 0.1M to about 6M, including each value within the specified range. Exemplary concentrations include, but are not limited to, about 0.1M, about 0.5M, about 1.0M, about 1.5M, about 2.0M, about 2.5M, about 3.0M, about 3.5M, about 4.0M, about 4.5M, about 5.0M, about 5.5M, and about 6.0M. Each possibility represents a separate embodiment.

Within the scope of the present invention is the further treatment of the permeate containing the desorbed rubidium ions in order to remove cations derived from the second eluent solution. Removal of NH₄⁺ ions can be performed by sublimation of ammonium salt, typically at a temperature higher than 200° C. (e.g., about 200° C. to about 400° C., including each value within the specified range), electro-oxidation, and/or high-pH stripping. Each possibility represents a separate embodiment. Removal of H⁺ ions can be performed by pH neutralization and/or acid evaporation. Each possibility represents a separate embodiment. According to the principles of the present invention, removal of the NH₄⁺ and/or H⁺ cations is performed such that at least 50%, 60%, 70%, 80%, or 90% of the initial NH₄⁺ and/or H⁺ cations in the permeate are removed. Each possibility represents a separate embodiment.

The process disclosed herein may also further regenerate the first column using sodium ions or acids. Sodium ions can be obtained from salts or strong bases which contain sodium, for example sodium chloride or sodium hydroxide. Each possibility represents a separate embodiment. Suitable acids include, but are not limited to, hydrochloric acid, sulfuric acid, nitric acid, acetic acid, and a combination thereof. Each possibility represents a separate embodiment.

The counterions of the eluent solutions may comprise SO₄²⁻, NO₃⁻, Cl⁻, and combinations thereof. Each possibility represents a separate embodiment. In some embodiments, the eluent solutions comprise NH₄⁺ ions and Cl⁻ counterions. In such embodiments, removal of the NH₄⁺ ions comprises the sublimation of ammonium chloride to result in ammonia gas and HCl gas. These gases can be further recycled for subsequent use.

According to the principles of the present invention, the flow rate at which the saline water and/or eluent solutions are passed through the columns ranges from about 0.1 BV/h to about 4 BV/h, including each value within the specified range. Typical flow rates are in the range of about 0.1 BV/h to about 2 BV/h, including each value within the specified range. Exemplary flow rates include, but are not limited to, about 0.1 BV/h, about 0.2 BV/h, about 0.3 BV/h, about 0.4 BV/h, about 0.5 BV/h, about 0.6 BV/h, about 0.7 BV/h, about 0.8 BV/h, about 0.9 BV/h, about 1.0 BV/h, about 1.5 BV/h, about 2.0 BV/h, about 2.5 BV/h, about 3.0 BV/h, about 3.5 BV/h, and about 4.0 BV/h. Each possibility represents a separate embodiment.

The temperature at which the steps disclosed herein are performed ranges from about 10° C. to about 70° C., including each value within the specified range. Exemplary temperatures include, but are not limited to, about 10° C., about 15° C., about 20° C., about 25° C., about 30° C., about 35° C., about 40° C., about 45° C., about 50° C., about 55° C., about 60° C., about 65° C., and about 70° C. Each possibility represents a separate embodiment. Currently preferred is the performance of the steps at room temperatures.

While the process may be performed using two columns (designated herein as a first column and a second column), n>2 columns may be utilized in the process of the present invention.

The process disclosed herein may be performed in a continuous operation mode or a batch operation mode, with each possibility representing a separate embodiment.

According to some embodiments, the separated rubidium ions of the present invention are obtained in the form of a rubidium salt. The rubidium salt can be recovered as is known in the art, for example by distillation, evaporation, solid-liquid separation, crystallization, and the like. Advantageously, the thus obtained rubidium salt, for example rubidium chloride, is characterized by exerting a high purity. According to the principles of the present invention, the purity of the rubidium salt obtained by the process is at least 90 wt. %, 95 wt. %, 98 wt. %, or 99 wt. %. Each possibility represents a separate embodiment. Thus, the process advantageously provides rubidium salt having less than 10 wt. %, 5 wt. %, 2 wt. %, or 1 wt. % of sodium and/or potassium ions.

The separation of rubidium from sodium and/or potassium cations by the process disclosed herein is typically characterized by a separation factor which is at or above about 5. In one embodiment, the separation of rubidium from potassium cations is characterized by a separation factor which is at or above about 6. In another embodiment, the separation of rubidium from potassium cations is characterized by a separation factor which is at or above about 7. In yet another embodiment, the separation of rubidium from potassium cations is characterized by a separation factor which is at or above about 8. In further embodiments, the separation of rubidium from potassium cations is characterized by a separation factor which is at or above about 9. In additional embodiments, the separation of rubidium from potassium cations is characterized by a separation factor of about 10.

In one embodiment, the separation of rubidium from sodium cations is characterized by a separation factor which is at or above about 50. In another embodiment, the separation of rubidium from sodium cations is characterized by a separation factor which is at or above about 100. In yet another embodiment, the separation of rubidium from sodium cations is characterized by a separation factor which is at or above about 200. In further embodiments, the separation of rubidium from sodium cations is characterized by a separation factor which is at or above about 250. In additional embodiments, the separation of rubidium from sodium cations is characterized by a separation factor of about 300.

The efficacy of separation of rubidium ions from the saline water is at least 30%, 35%, 40%, 45%, or 50%. Each possibility represents a separate embodiment. The yield of the process of the present invention is at least 10% and typically in the range of 10% to 30%, including each value within the specified range. Exemplary yields include, but are not limited to 10%, 11%, 12%, 13%, 14%, 15%, 16%, 17%, 18%, 19%, 20%, 21%, 22%, 23%, 24%, 25%, 26%, 27%, 28%, 29%, 30%, or more. Each possibility represents a separate embodiment.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

As used herein, the term “about” when combined with a value refers to +10% of the reference value.

As used herein, the term “room temperatures” refers to temperatures in the range of about 10° C. to about 35° C., including each value within the specified range.

It is noted that as used herein and in the appended claims, the singular forms “a”, “an”, and “the” include plural referents unless the context clearly dictates otherwise. Thus, for example, reference to “a column” includes a plurality of such columns, and so forth. It is further noted that the claims may be drafted to exclude any optional element. As such, this statement is intended to serve as antecedent basis for use of such exclusive terminology as “solely”, “only” and the like in connection with the recitation of claim elements or use of a “negative” limitation.

In those instances where a convention analogous to “at least one of A, B, and C, etc.” is used, in general such a construction is intended in the sense one having skill in the art would understand the convention (e.g., “a complex comprising at least one of A, B, and C” would include but not be limited to complexes that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such sub-combination was individually and explicitly disclosed herein.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

### Materials and Methods

### PES-Zn-HCF Preparation

Synthesis of the Zn-HCF crystals was performed as described in Takahashi et al., (Chem Eng Res Design. 109 (2016) 513-518, https://doi.org/10.1016/j.cherd.2016.02.027). ZnCl₂ solution (0.5 M) was mixed with a potassium hexacyanoferrate (K₄[Fe(CN)₆]·3H₂O) solution (0.5 M) at a 3:2 volume ratio for forming a homogeneous slurry, which was then centrifuged, washed with deionized water, dried, and sieved (Mesh #35), for the formation of Zn-HCF(s) powder. To enable reactor operation without particle washout, the Zn-HCF powder was encapsulated in PES polymer for the formation of PES-Zn-HCF beads using the phase inversion technique. The encapsulation was carried out as described in Nativ et al., (Water Res. 203 (2021), https://doi.org/10.1016/j.watres.2021.117551). The Zn-HCF powder was mixed with PES (BASF Ultrason E grade 6020P) flakes dissolved in N-ethyl-2-pyrroludone (NMP) (ratio of 1:4 PES to Zn-HCF powder) for forming a homogeneous slurry, which was dripped into a water bath at room temperature to form the beads.

### Characterization of the Synthesized PES Zn-HCF Beads

### Physical Analyses:

The surfaces of the Zn-HCF powder and PES-Zn-HCF beads were imaged using a high-resolution scanning electron microscopy (HRSEM, Ultra-Plus FEG-SEM, Zeiss) and the elements' spatial distribution in the beads was analyzed by an energy-dispersive X-ray detector (EDS, Bruker Xflash x-ray energy dispersive spectrometer).

### Chemical Characteristics Analyses:

A batch-based adsorption test with a Cs⁺-filled Zn-HCF powder was performed to determine the total cation exchange capacity, which was found to be 2.4 meq/g. To determine the binary separation factor (a), 0.1 g of Zn-HCF powder loaded with Na⁺ ions was tested in different backgrounds with various NaCl concentrations (0, 1, 10.2, 30.5 and 61 g/L), and 5 mM of either K⁺, NH₄⁺ or Rb⁺. The solution was stirred at a constant temperature of 25° C. for 72 h. The binary separation factors were then calculated using Eq. 1.

$${α}_{{Na}^{+}}^{{X}^{+}} = \frac{{( {X}^{+} )}_{eq} \cdot {( {Na}^{+} )}_{ads}}{{( {Na}^{+} )}_{eq} \cdot {( {X}^{+} )}_{ads}} , \qquad ( 1 )$$

where

$${α}_{{Na}^{+}}^{{X}^{+}}$$

denotes the separation factor between Na⁺ and K⁺, NH₄⁺ or Rb⁺, represented by X⁺; ( )_{eq} denotes the equilibrium concentration in the bulk solution; and ( )_{ads} denotes the adsorbed concentration, calculated using the total ion exchange capacity.

### Adsorption Isotherms:

The adsorption isotherms were obtained using three replicates of 125 mg Zn-HCF powder in 100 ml solution of Mediterranean seawater (SW) at a wide range of initial Rb⁺ concentrations (0-1,000 mg/L). The experiment was conducted at a constant temperature of 25° C. for 24 h and 72 h. The adsorption capacity (q, mg Rb/g Zn-HCF) was calculated using Eq. 2.

$$q = ( {C}_{0} - {C}_{i} ) \cdot \frac{V}{m} , \qquad ( 2 )$$

where C is the Rb concentration (the 0 and i notations correspond to the initial and time dependent concentration, respectively); V is the solution volume; and m is the resin mass. The empirical results were fitted to a Langmuir isotherm model.

### Batch Experiments:

In order to examine the cation desorption patterns, three batch experiment replicates were performed using 100 mL eluents with varied NH₄Cl concentrations (0, 0.025, 0.05, 0.075, 0.1, 0.3, 0.5, 0.8 and 1 M) at different temperatures (15, 25 and 35° C.). Each test consisted of 0.25 g Zn-HCF in the form of PES-Zn-HCF beads, loaded with either Na⁺, K⁺ or Rb⁺. Samples were collected for analysis after 1, 4 and 24 h.

### Ion Exchange Simulations:

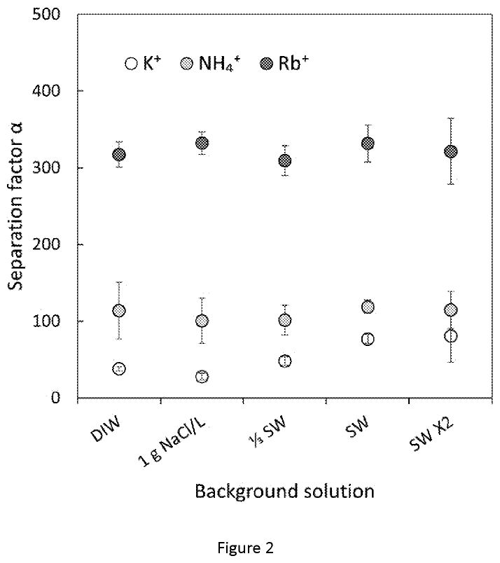

The simulations to determine the applicable working conditions for cation desorption from the PES-Zn-HCF column were performed using the PHREEQC software (Advection model, using the wateq4f.dat database, Charlton et al., Comput Geosci. 37 (2011) 1653-1663, https://doi.org/10.1016/j.cageo.2011.02.005). The total capacity of the resin and the separation factor results (FIG. 2) obtained in the study were used as input. The simulation assumed a PES-Zn-HCF column already adsorbed with Rb⁺, Na⁺ and K⁺ at 8, 31, and 61% (Molar-based), respectively, either as a standalone column or as the first column in a pair, with the subsequent column fully occupied by NH₄⁺.

### Column Experiments:

To attain the Rb⁺ (8%), Na⁺ (31%) and K⁺ (61%) occupancy (eq. ratio) in the adsorbing material, the following was performed: 2 kg of Zn-HCF beads were placed in a saturated NaCl solution for 72 hours and then thoroughly rinsed with DIW to validate the working assumption that all the adsorption sites were occupied with Na⁺. The beads were then placed in a RbCl/KCl solution (730 mg/L as Rb and 2,800 mg/L as K, respectively) for 72 hours. The final adsorbed ratios were calculated based on the difference between the initial and final cation concentrations in the adsorbing solution. The beads were then rinsed again with DIW.

In the one-column experimental setup, the PES-Zn-HCF beads were pre-adsorbed with Rb⁺, K⁺ and Na⁺ and packed in a column (BV=442 mL, I.D=3.2 cm, H=55 cm, 195 g of Zn-HCF powder in the form of composite beads) and rinsed with 3 liters of DIW. The ammonium eluent solutions (NH₄Cl 0.05, 0.1 and 1 M) were pumped through the column at a constant flow rate of 0.7 BV/h. Samples of momentary and cumulative concentrations were taken for analysis, with the total duration set according to the PHREEQC simulations.

In the two-columns experimental setup, a pair of PES-Zn-HCF beads' columns (same dimensions as listed above) were placed in series. The first column was loaded with PES-Zn-HCF beads pre-adsorbed with Rb⁺, K⁺ and Na⁺, while the second column was pre-adsorbed with NH₄⁺. The ammonium eluent solutions (NH₄Cl 0.05, 0.1 and 1 M) were pumped through the column at a constant flow rate of 0.7 BV/h. Samples of momentary and cumulative concentrations were taken for analysis.

### NH₃ and HCl Sublimation Experiments:

Following the passage of the 1M NH₄Cl through the second PES-Zn-HCF column, the cumulative effluent was collected and the NH₄Cl was separated from the other salts via sublimation. Specifically, the solution was dried at 200° C. until all the water evaporated. The resulting salts were placed in a porcelain dish and heated over an open flame for 30 minutes, leading to the decomposition and sublimation of NH₄Cl as NH₃ and HCl gases. The remaining material was then rinsed with 25 ml of DIW, passed through a 0.22 m filter, and dried. The remaining salt was characterized by XPS (ESCALAB QXi, Thermo Scientific, USA).

### Cost Assessment:

Simulated phosphate industrial wastewater was prepared based on pre-characterization of this water source (Vengosh et al., Sci Total Environ. 850 (2022) 157971, https://doi.org/10.1016/j.scitotenv.2022.157971). For the first adsorption step, PES-Zn-HCF beads, pre-adsorbed with Na⁺, were loaded in a column with the same dimensions and operating conditions as those above. The adsorption solution (phosphate industrial wastewater) was pumped through the column at a constant flow rate of 1 BV/h. Samples were intermittently collected from the effluent of the column and subjected to analysis.

The regeneration of the adsorbent material was accomplished by a 1M NH₄Cl solution, at a flow rate of 0.25 BV/h. The effluent obtained during the regeneration phase was collected and subjected to drying until crystallization occurred. The ammonium component was subsequently sublimated following the procedure outlined above. The remaining salt was dissolved in DIW and analyzed via ICP.

The second adsorption step was performed on a column loaded with PES-Zn-HCF beads pre-adsorbed with Na⁺. The adsorbent solution employed in this step was derived from the effluent obtained during the regeneration process: A simulated solution was prepared according to the salt cationic components and concentrations diluted in a ratio of 1 to 3.4 L of DIW. A flow rate of 0.5 BV/h was used.

The following cost of chemicals, energy and CAPEX were used for calculating the cost estimation: PES-Zn-HCF beads were estimated at 18.5 $/L beads (Nativ et al., ChemEngineering. 6 (2022) 97, https://doi.org/10.3390/chemengineering6060097), construction of acid-resistant concrete reactor (laminated with rubber) was estimated at 400 $/m³ (Eng. A Menuchin, EPT ltd., personal communication, May 2023), with a 5% annual interest and lifespan of 15 years. Electricity cost of 0.0859 $/kWh (U.S. Energy Information Administration, Electric Power Monthly: with data for April 2023, Independent Statistics & Analysis. (2023). https://doi.org/10.2172/123200); electrochemical oxidation of TAN at 37.9 kWh/kgN (Nativ et al., ChemEngineering. 6 (2022) 97, https://doi.org/10.3390/chemengineering6060097); drying and crystallization at 190 kW-heat/ton solution (Dahmardeh et al., Chem Eng Proc—Process Intensification. 145 (2019), https://doi.org/10.1016/j.cep.2019.107682); sublimation at 3.5 kW-heat/kgN (Zhu et al., J Phy Chem C. 111 (2007) 13831-13838, https://doi.org/10.1021/jp073448w); ratio between W-electrical/W-heat of 2 instead of 3 was taken as a safety factor (Shen et al., Renew Sustain Energ Rev. 50 (2015) 346-362, https://doi.org/10.1016/j.rser.2015.04.129); NaOH, NaCl andNH₄Cl at 700, 50, and 1,600 $/ton, respectively (Nativ et al., ChemEngineering. 6 (2022) 97, https://doi.org/10.3390/chemengineering6060097; and https://www.statista.com/statistics/916733/us-salt-prices-by-type/, Statista Inc. (2022); OPEX assumptions: 5% annual replacement of the PES-Zn-HCF beads.

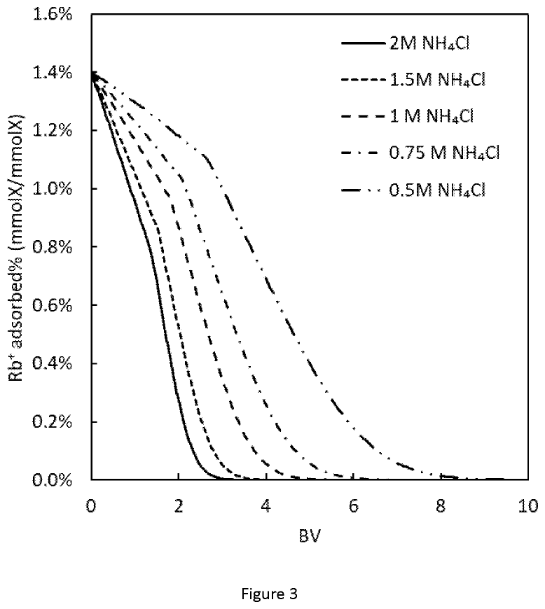

In the calculations, the following assumptions were taken for the 1^{st} step: Feed flow rate of 1,000 m³/h, retention time of 1 BV/h, a 1,000 m³ column, adsorption step of 150 BV (~6 days), desorption step of 15 BV, eluent solution of [NH₄Cl]=1 M (FIG. 3). For the 2^{nd} step, two 50 m³ columns, one used solely for the adsorption step, and both used in series for the selective desorption step. These volumes were based on the estimated concentrations of Rb⁺, Na⁺ and K⁺ in the desorption solution. An initial adsorption step of 150 BV at a retention time of 1 BV/h; for the selective desorption step two NH₄Cl eluents were considered: 0.05 M for the 1^{st} desorption (58 BV) and 1 M for the final desorption step (13.5 BV).

### Analyses:

Elemental cation concentrations were determined using ICP-OES (PlasmaQuant PQ 9000 Elite, High-Resolution Array, Analytik Jena AG, Germany). For measuring Rb concentrations, a CsCl buffer was used (concentration of 250 mg/L as Cs). Total ammonia nitrogen was determined using the salicylate method as described in Willis et al., (J Agric Food Chem. 44 (1996) 1804-1807, https://doi.org/10.1021/jf950522b).

### Example 1

### Characterization of the PES-Zn-HCF Beads

A comprehensive characterization of the PES-Zn-HCF beads was performed with emphasis on the adsorption capacity and selectivity for rubidium ions.

The binary separation factor value (a), commonly used in ion exchange calculations, is known to depend on a variety of solution and operational factors such as the ionic strength of the bulk solution, pH, temperature, and the crystal structure of the ion exchange resin (Jiang et al., RSC Adv. 8 (2018) 34573-34581, https://doi.org/10.1039/C8RA07421F; Marei et al., J Radioanal Nucl Chem. 104 (1986) 217-222, https://doi.org/10.1007/BF02165325; Crittenden et al., Ion Exchange, in: MWH's Water Treatment: Principles and Design, John Wiley & Sons, Inc., Hoboken, NJ, USA, 2012: pp. 1263-1334, https://doi.org/10.1002/9781118131473.ch16; Vlasselaer et al., J Radioanall Chem. 35 (1977) 211-222, https://doi.org/10.1007/BF02518228). To estimate the a values at conditions resembling the conditions of the experiments, tests were conducted with several background solutions encompassing a wide range of NaCl concentrations, as Rb⁺ can be found in different types of natural saline sources (Table 1). The average separation factor values obtained in this study were Na⁺:K⁺:NH₄⁺:Rb⁺→1:28 (±4.3):101 (±29):305 (±15), as shown in FIG. 2. The results highlight the high affinity of the Zn-HCF material toward K⁺ and NH₄⁺, and particularly toward Rb⁺. Moreover, as apparent from FIG. 2, the measured separation factor values were not significantly affected by changes in the background solution, with emphasis on NH₄⁺ and K⁺.

TABLE 1

| | Concentration (mg/L) | | | | |
|---|---|---|---|---|---|
| Source | [Rb⁺] | [Na⁺] | [K⁺] | [Cs⁺] | [Li⁺] |
| SWRO brine, Perth Australia | 0.2 | 22,100 | 783 | — | 0.1 |
| Potassium Industrial Waste, | 20 | 19,390 | 2,770 | 2 | 685 |
| Taijnar Lake, China | | | | | |
| Phosphate Industrial Waste, | 15.27 | 15,765 | 6,508 | — | 11,164 |
| Israel | | | | | |
| Qarham playa, China | 0.23 | 1,410 | 80 | 0.012 | 0.59 |
| Yesilhisar Dutluk springs, | 0.15 | 1,682 | 45 | — | — |
| Turkey | | | | | |
| Tiberias Springs, Israel | 0.12 | 6,900 | 383 | — | — |
| Ein Noit Springs, Israel | 0.04 | 5,630 | 368 | — | — |
| Eiland Springs, South Africa | 0.13 | 622 | 22 | — | — |
| Soutini Springs, South Africa | 0.10 | 3,487 | 31 | — | — |
| Salton Salt Lake, USA | 169 | 51,000 | 25,000 | 20 | 300 |

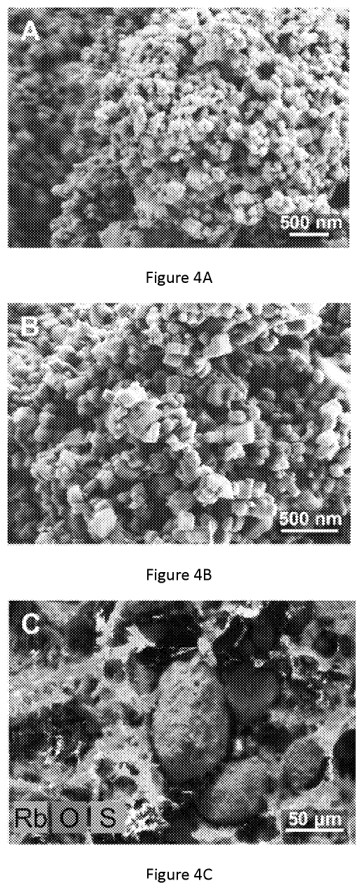

SEM images of the Zn-HCF powder (FIG. 4A) and the PES-Zn-HCF beads (FIG. 4B) show the cubic structure of the cyanoferrate. The size and structure of the Zn-HCF crystals were not altered by the PES polymer coating. The EDS detector-based SEM image, shown in FIG. 4C, depicts the spatial distribution of PES-Zn-HCF beads loaded with Rb⁺ ions. The Zn-HCF presence (indicated by the atoms Zn, N, and Fe) spatially correlated with the presence of rubidium. The PES was indicated by the O and S elements. Upon examining all the relevant elements, an increased presence of rubidium is shown to be accompanied by the presence of elements in the HCF (Zn, N, Fe), contrary to the PES areas, where only O and S were apparent. This indicates that the beads' structure contains aggregates of Zn-HCF (~10 μm particles) which are surrounded by the polymer.

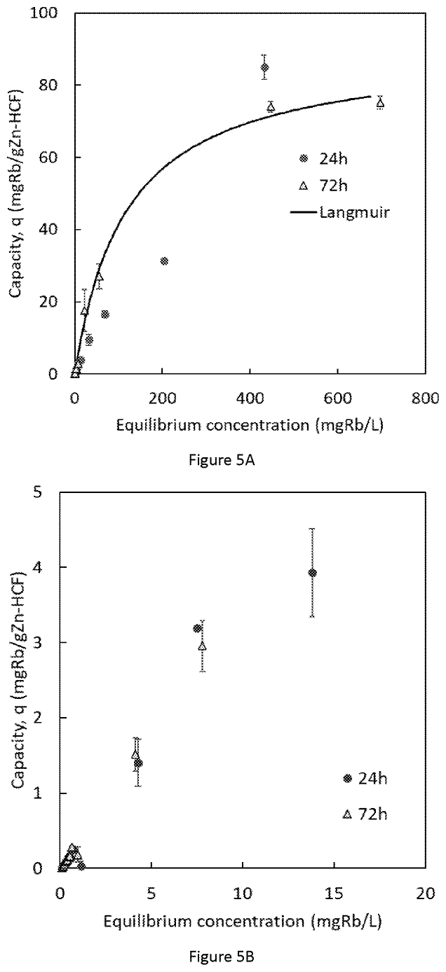

To determine the adsorption capability of the Zn-HCF powder for Rb⁺, an adsorption isotherm was obtained at a constant temperature of 25° C. To this end, seawater (SW) was used as a natural solution that contains both Rb⁺ ions and a high concentration of competitive cations. The total measured capacity in SW was found to be 90.2 mgRb/gZn-HCF (FIGS. 5A and 5B). The Langmuir model was successfully applied to the data, with Langmuir constants of Qₘₐₓ=90.2 mgRb/gHCF; K_{L}=0.0085, and R²>0.95 (FIG. 5A). Similar results were obtained in 24-hours and 72-hours isotherm experiments, indicating that a 24-hours' time frame was sufficient for approaching steady state.

### Example 2

### Batch Desorption Experiments

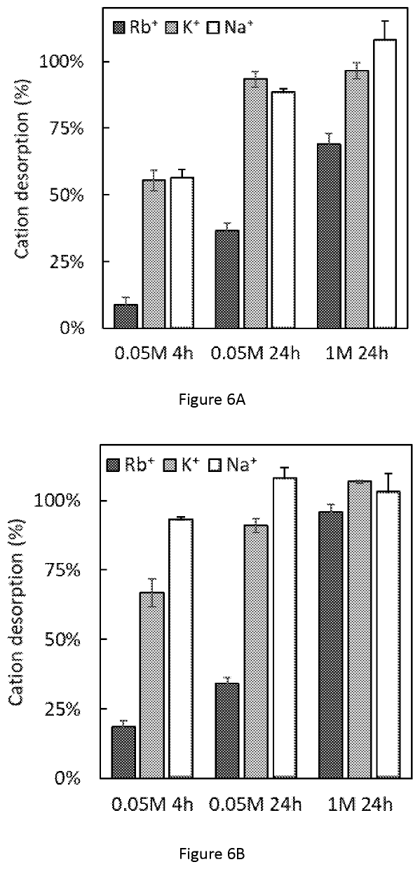

FIG. 2 shows significant difference in selectivity among the relevant monovalent cations, which can be used for selectively separating the Rb⁺ from the other cations. To test the separation potential, PES-Zn-HCF beads were soaked in concentrated NaCl, KCl, and RbCl solutions for 72 hours, then washed with DIW and inserted into 0.1 L NH₄Cl solutions at 25 and 35° C. The cation concentrations were measured in the solutions after 4 and 24 hours in 0.05 and 1 M NH₄Cl. FIGS. 6A-6B show that an increased ammonium concentration and a higher retention time resulted in increased desorption of cations. The Zn-HCF exerts a higher affinity toward NH₄⁺ as compared to Na⁺ and K⁺ but a lower affinity toward NH₄⁺ relative to Rb⁺. Thus, at the low NH₄⁺ concentration (0.05 M), a significant desorption of Na⁺ and K⁺ occurred, while the Rb⁺ release was minimal. Conversely, when the NH₄⁺ concentration was raised to 1 M, full desorption of the Rb⁺ from the adsorption sites was observed. It was thus concluded that by controlling the NH₄⁺ concentration, selective cation desorption from Zn-HCF could be induced. The change in temperature did not significantly affect the desorption pattern, hence all the subsequent experiments was performed at room temperature.

### Example 3

### Continuous Desorption Experiments

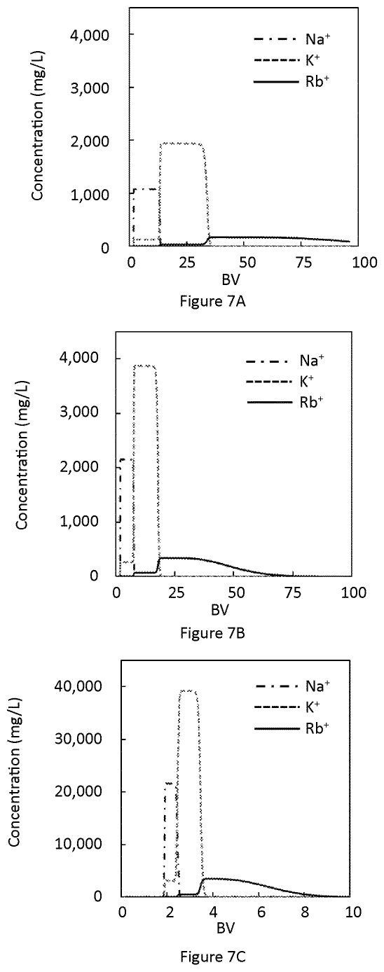

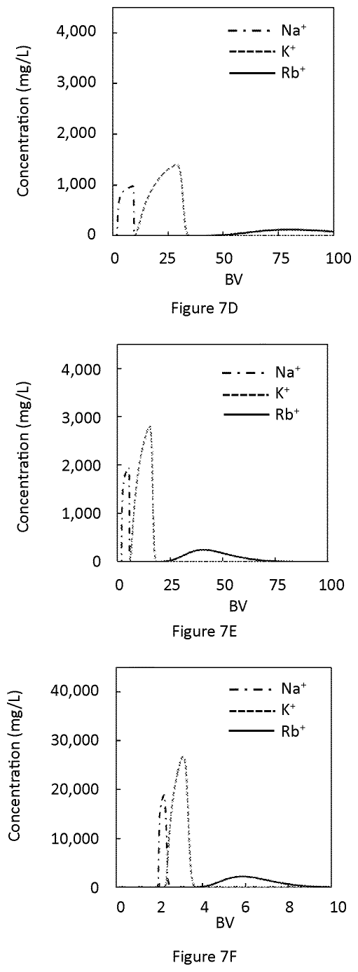

FIGS. 7A-7F depict the results of cation desorption simulations performed with the PHREEQC software, using the obtained separation factors. The loaded PES-Zn-HCF column was subjected to various concentrations of ammonium chloride eluent. Due to the different affinities of the cations to the Zn-HCF, the concentration of the different cations in the outflow solution was time dependent. The simulation showed that the best separation could be achieved by adding a second column, pre-adsorbed with NH₄⁺, as demonstrated in FIGS. 7D-7F.

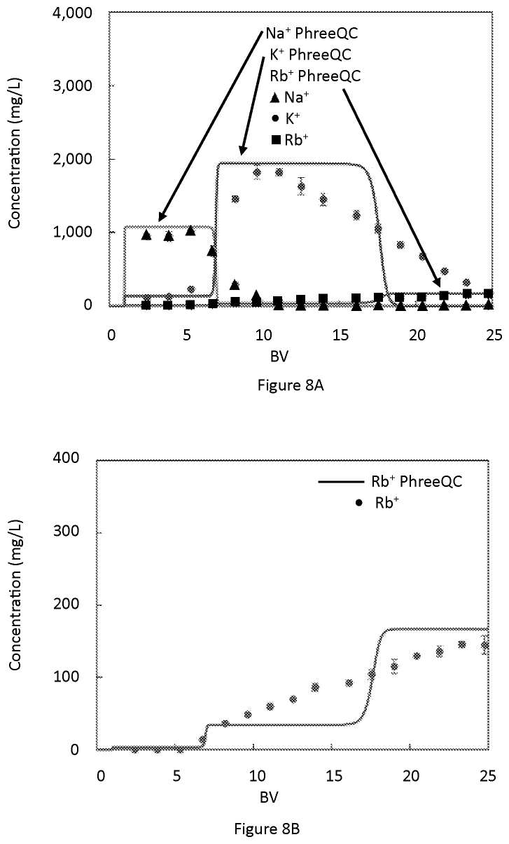

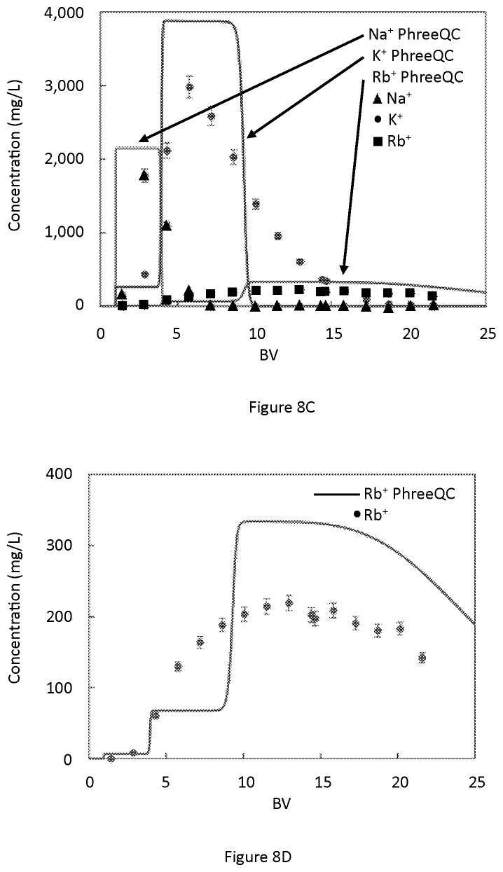

To validate the PHREEQC simulations, a similar 2-column experiment was performed using NH₄Cl as an eluent at 0.05 and 0.1 M (FIGS. 8A and 8C, respectively) under similar conditions of column size and initial cation composition. The cation concentrations were sampled from the solution flowing out of the 1^{st} and 2^{nd} columns. Separation was observed between the peaks of the different cations, which corresponded well with the simulation results. The difference between the simulations and the measurements was attributed to the lack of consideration for dispersion and diffusion in the simulation runs.

Although some separation between the different cations was observed in the 1^{st} column's product, to improve the separation between Rb⁺ and Na⁺/K⁺, a second column, pre-adsorbed with NH₄⁺, was added. This resulted in a relatively fast passage of Na⁺ and K⁺ through the second column, while Rb⁺, with the highest affinity towards the adsorbing material, underwent renewed adsorption and was released at a later stage.

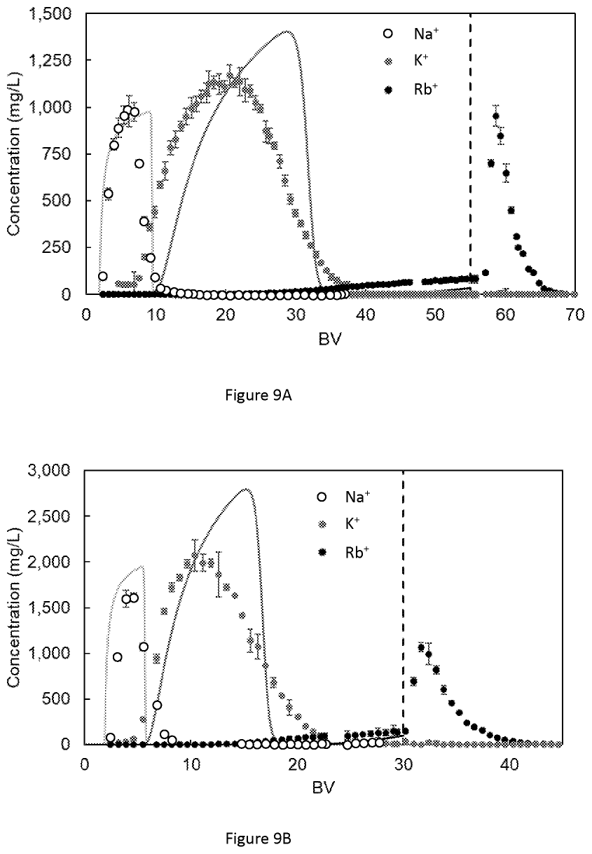

A second experiment was carried out to assess the effectiveness of the Rb⁺ separation from the PES-Zn-HCF column by introducing a second column, pre-loaded with NH₄⁺, with identical dimensions. The experiments were conducted with eluent concentrations of 0.05 and 0.1 M. The results, along with matching PHREEQC simulations, are presented in FIGS. 9A and 9B, respectively. The extension of the adsorbing material to the second column yielded a significant separation between the various cations. After 55 and 30 BV (for eluent concentrations of 0.05 and 0.1 M, respectively), the concentration of K⁺ and Na⁺ decreased to almost zero. A high-concentration eluent solution (1 M) was then injected to release all the remaining adsorbed Rb⁺. By using 0.1 M NH₄Cl as the first eluent, a total mass of 29 mg of K⁺ and 44 mg of Na⁺ was obtained in the collected solution following the high concentrated eluent flow. When 0.05 M was used as the first eluent solution, a better separation was obtained, with practically no K⁺ or Na⁺. Therefore, the next stage, which involved NH₄Cl removal and pure RbCl production, was conducted based on the results obtained with 0.05 M of NH₄Cl. The solution was collected, dried, and the remaining solid salt was obtained.

### Example 4

### Obtaining Pure RbCl(s) by Separating Ammonium Chloride Through Sublimation

After passing 1 M NH₄Cl eluent through the column, the resulting solution product volume was 5.5 L at a concentration of 230 mg/L of Rb⁺, with no Na⁺ and K⁺, but with a high background of NH₄⁺ (~1M concentration). The solution was dried, yielding a solid material, containing RbCl, but mainly NH₄Cl. Thereafter, the temperature was raised to −350° C. resulting in NH₃ and HCl sublimation, that was used to separate the NH₄Cl from the RbCl. The sublimation process did not yield any measurable TAN in the remaining solid mass.

XPS analysis was performed on three replicates of the solid that remained following sublimation. The results indicated that the obtained substance (excluding lab-artifact impurities that stemmed from the heat applied during sublimation) was a RbCl salt at a high purity level of 99.5% (±1.5%). Notably, the sublimation product showed no detectable presence of K and exhibited an extremely low concentration of Na.

The total RbCl mass obtained from the process was 1.9 g. The efficiency of RbCl production, following the chromatographic selective separation, amounted to 61% of the initially adsorbed Rb⁺. Following sublimation, the efficiency dropped to ~50%.

### Example 5

### Cost Assessment

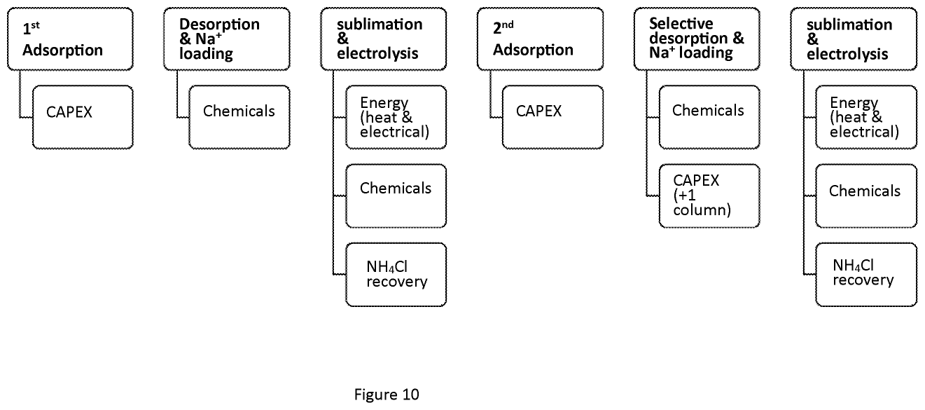

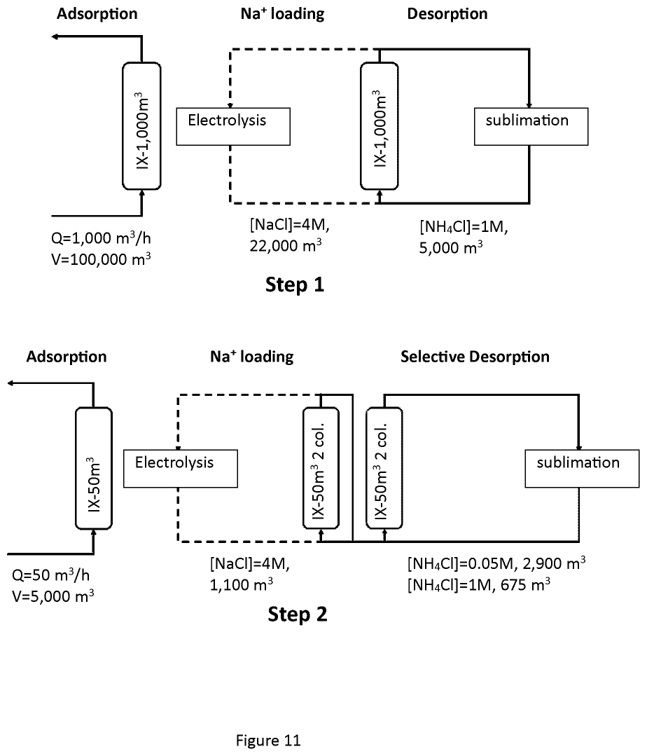

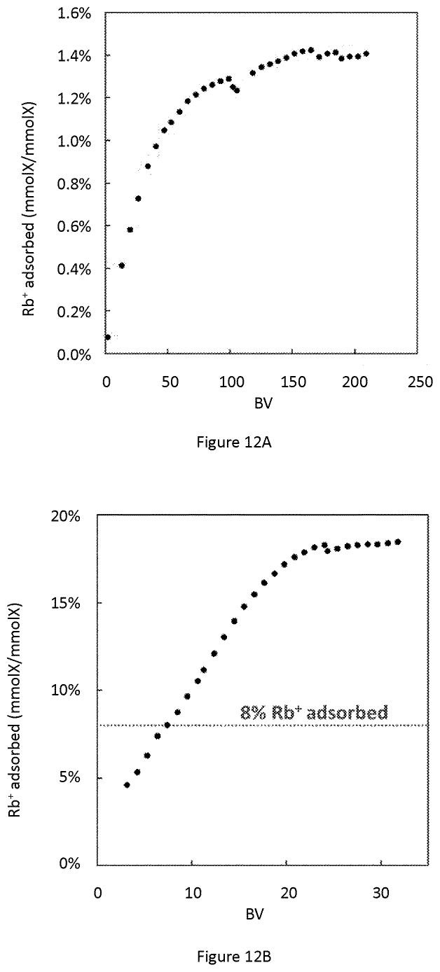

To estimate the economic feasibility of the proposed process, the following full process design was investigated (FIGS. 10 and 11). The process was separated into two main steps. The 1^{st} step included an initial adsorption of Rb⁺ ions (i.e., adsorption of Rb⁺ into a large mass of adsorbing material) from Phosphate Industrial Waste, Israel (Table 1). The breakthrough curve for the simulated water, presented in FIG. 12A, showed that 1.4% of the material's sites, were occupied by Rb⁺ after 150 BV, followed by a desorption step of 15 BV, using a 1 M NH₄Cl solution (PHREEQC simulations of the desorption step shown in FIG. 3 with a ×3 safety factor). Then, the column underwent Na⁺ loading, to enable another Rb⁺ loading cycle. The 2^{nd} step process was assumed similar, however with a smaller mass of adsorbing material (the breakthrough curve for the simulated water appears in FIG. 12B). The initial working conditions of 8% Rb⁺ adsorbed on the column, as presented in the chromatography experiments (FIGS. 8A-8D and 9A-9B), were achieved after 7.5 BV.

The exhausted Na⁺ loading solutions were assumed to be treated by electrolysis for TAN removal, as described in Nativ et al., (ChemEngineering. 6 (2022) 97, https://doi.org/10.3390/chemengineering6060097) and Gendel et al., (Electrochim Acta. 63 (2012) 209-219, https://doi.org/10.1016/j.electacta.2011.12.092) and the Rb⁺-containing eluent solutions were treated by drying and sublimation.

Considering that Rb⁺ was obtained in the separation process at 50% efficiency, production of ~350 kg Rb per cycle was utilized for the cost calculations. The cost results are presented in Table 2. The overall cost was estimated at ~1,300 $/kg Rb. Noticeable is the expected high fraction in the cost of the first step, due to the large volumes of reactors and solutions.

TABLE 2

| | | Units | 1^{st} step | 2^{nd} step |
|---|---|---|---|---|
| OPEX | Heat energy | $/cycle | 152,501 | 30,901 |
| | Electrical energy | $/cycle | 32,560 | 1,628 |
| | Chemicals and IX | $/cycle | 165,911 | 9,200 |
| CAPEX | Zn-HCF | $/cycle | 60,912 | 3,046 |
| | Columns | $/cycle | 1,281 | 64 |
| | Chemicals | $/cycle | 2,440 | 132 |
| CAPEX | Total | $/cycle | 350,972 | 41,729 |
| OPEX | Total | $/cycle | 64,633 | 3,241 |
| | Total | $/kg Rb | 1,330 | |

A new method is presented herein for separating pure RbCl(s) from brines that contain much higher concentrations of Na⁺ and K⁺. The separation was carried out using a reactor filled with Zn-HCF particles covered by PES. The Zn-HCF was characterized by a high affinity towards Rb⁺, which was found to be approximately 305, 10.9 and 3 fold higher than its affinity toward Na⁺, K⁺ and NH₄⁺, respectively. The difference in affinities was used to (1) adsorb Rb⁺ from solutions in which its concentration was many orders of magnitude lower than that of Na⁺ and K; (2) apply regeneration with 0.05 M NH₄⁺ through the adsorption column, followed by another column pre-adsorbed with NH₄⁺, such that most of the Rb⁺ mass remained adsorbed on the 2 columns, and substantially all of the Na⁺ and K⁺ ions were flushed out; (3) release all the remaining Rb⁺ by 1 M NH₄⁺ eluent; and (4) remove (and recover) the ammonia component by sublimation of NH₃ and HCl and subsequent precipitation of NH₄Cl. The final product obtained by the process disclosed herein is a highly pure rubidium salt (RbCl(s)). A detailed cost assessment was carried out on a theoretical waste solution from a phosphate extraction industry (Vengosh et al., Sci Total Environ 850 (2022) 157971, https://doi.org/10.1016/j.scitotenv.2022.157971) which revealed the production costs to amount to ~$1300/kg as Rb. The cost estimated constitutes to less than 20% of the current chemical market price.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A process for the selective separation of rubidium ions from saline water, the process comprising the steps of:
(a) passing saline water comprising rubidium ions and at least one of sodium ions and potassium ions through a first column comprising a plurality of metal-hexacyanoferrate particles which is pre-loaded with cations selected from Na⁺, H⁺, and a combination thereof,
(b) passing a first eluent solution through the first column of step (a);
(c) treating the permeate of step (b) to remove cations derived from the first eluent solution;
(d) passing the treated permeate of step (c) through a second column comprising a plurality of metal-hexacyanoferrate particles pre-loaded with cations selected from NH₄⁺, H⁺, and a combination thereof, and
(e) passing a second eluent solution through the second column of step (d) thereby obtaining selective separation of rubidium ions from the saline water.

2. The process of claim 1, wherein the water is wastewater derived from phosphate industrial waste or potassium industrial waste; or wherein the water is obtained from a source selected from an ocean, a sea, a river, a lake, a spring, and an inland water body; or wherein the water is seawater or the retentate derived from seawater desalination operation.

3. The process of claim 1, wherein the water comprises rubidium ions and sodium ions, wherein the concentration of the sodium ions is at least 100-fold higher than the concentration of the rubidium ions; or wherein the water comprises rubidium ions and potassium ions, wherein the concentration of the potassium ions is at least 10-fold higher than the concentration of the rubidium ions.

4. The process of claim 1, wherein the metal-hexacyanoferrate particles comprise a metal selected from the group consisting of zinc, cobalt, copper, nickel, chromium, vanadium, iron, and combinations thereof.

5. The process of claim 1, wherein the metal-hexacyanoferrate particles are coated with or embedded in a polymer selected from polyether sulfone, polyester, polyurethane, polypropylene, polystyrene, polycarbonate, polyimide, polyphenylene, polyamide, polyether imide, polyphenyl sulfone, polyvinyl, polysulfone, polyvinylidene fluoride, polytetrafluoroethylene, and a mixture or combination thereof.

6. The process of claim 1, wherein the metal-hexacyanoferrate particles are in the form of beads, pellets, granules, flakes, or a mixture or combination thereof.

7. The process of claim 6, wherein the metal-hexacyanoferrate particles are in the form of beads having an average diameter in the range of about 0.1 μm to about 10 mm.

8. The process of claim 1, wherein the flow rate at which the saline water and/or eluent solutions are passed through the columns ranges from about 0.1 BV/h to about 4 BV/h.

9. The process of claim 1, further comprising step (aᵢ) of measuring the content of rubidium ions of the total ions adsorbed onto the metal-hexacyanoferrate particles following step (a).

10. The process of claim 9, further comprising the following steps if the content of rubidium ions adsorbed onto the metal-hexacyanoferrate particles is at or below a predetermined threshold:
(aᵢᵢ) regenerating the metal-hexacyanoferrate particles of step (a) using cations selected from NH₄⁺, H⁺, and a combination thereof;
(aᵢᵢᵢ) treating the permeate of step (aᵢᵢ) to remove the NH₄⁺ and/or H⁺ ions; and
(aᵢᵥ) passing the treated permeate of step (aᵢᵢᵢ) through the regenerated column of step (aᵢᵢ).

11. The process of claim 10, comprising repeating steps (aᵢ) to (aᵢᵥ) until the content of rubidium ions adsorbed onto the metal-hexacyanoferrate particles is above the predetermined threshold.

12. The process of claim 10, wherein step (aᵢᵢ) is performed using a solution comprising NH₄⁺ ions at a concentration in the range of about 0.01M to about 3M and wherein step (aᵢᵢᵢ) is performed by one or more of sublimation of ammonium salt, electro-oxidation, and high-pH stripping; or wherein step (aᵢᵢ) is performed using a solution comprising H⁺ ions at a concentration in the range of about 0.1M to about 6M and wherein step (aᵢᵢᵢ) is performed by one or more of pH neutralization, and acid evaporation.

13. The process of claim 1, wherein the first eluent solution comprises NH₄⁺ ions at a concentration in the range of about 0.01M to about 0.1M.

14. The process of claim 13, wherein step (c) comprises treating the permeate of step (b) to remove NH₄⁺ ions by one or more of sublimation of ammonium salt, electro-oxidation, and high-pH stripping.

15. The process of claim 1, wherein the first eluent solution comprises H⁺ ions at a concentration in the range of about 0.1M to about 6M.

16. The process of claim 15, wherein step (c) comprises treating the permeate of step (b) to remove H⁺ ions by one or more of pH neutralization, and acid evaporation.

17. The process of claim 1, wherein the second eluent solution comprises NH₄⁺ ions at a concentration in the range of about 0.01M to about 3M; or wherein the second eluent solution comprises H⁺ ions at a concentration in the range of about 0.1M to about 6M.

18. The process of claim 17, wherein the second eluent solution comprises NH₄⁺ ions and/or H⁺ ions at a higher concentration than the concentration of NH₄⁺ ions and/or H⁺ ions in the first eluent solution.

19. The process of claim 1, wherein steps (b) through (d) are performed continuously; and/or wherein steps (b) through (d) are repeated until substantially no sodium and/or potassium ions which are desorbed from the metal-hexacyanoferrate particles upon passage of the first eluent are released.

20. The process of claim 1, further comprising step (f) of treating the permeate of step (e) to remove cations derived from the second eluent solution; and/or further comprising step (g) of regenerating the first column using sodium ions or acids.
